(19) United States
(12) Patent Application Publication
(10) Pub. No.: US 2016/0087663 A1
(43) Pub. Date: Mar. 24, 2016

(54) WIRELESS COMMUNICATION DEVICE

(71) Applicant: Wistron Corporation, New Taipei City (TW)

(72) Inventor: Yin-Tsai Wang, New Taipei City (TW)

(21) Appl. No.: 14/505,501

(22) Filed: Oct. 3, 2014

(30) Foreign Application Priority Data
Sep. 18, 2014 (TW) 103132252

(51) Int. Cl. H04B 1/12; H04W 72/04

(52) U.S. Cl. CPC H04B 1/123; H04W 72/0453

(57) ABSTRACT

A wireless communication device is provided. The wireless communication device includes a first wireless communication protocol transceiver, a second wireless communication protocol transceiver, a signal frequency splitter and a signal filter. The first wireless communication protocol transceiver accesses data with a first wireless communication protocol. The signal frequency splitter splits a receiving signal received by a second antenna and a transmitting signal transmitted by the second antenna according to a receiving frequency band and a transmitting frequency band of a second wireless communication protocol. The signal filter coupled to the signal frequency splitter and a receiving terminal of the second wireless communication protocol transceiver filters a signal in a receiving frequency band of the first wireless communication protocol and the receiving frequency band of the second wireless communication protocol.

### CROSS-REFERENCE TO RELATED APPLICATION

This application claims the priority benefit of Taiwan application serial no. 103132252, filed on Sep. 18, 2014. The entirety of the above-mentioned patent application is hereby incorporated by reference herein and made a part of this specification.

### BACKGROUND

1. Technical Field

The disclosure relates to a wireless communication technique, and particularly relates to a wireless communication device capable of performing data transmission through a plurality of wireless communication protocols and avoiding receiving noises generated due to an inter-modulation effect.

2. Related Art

Along with progress of integrated circuit (IC) manufacturing process, a same electronic equipment (for example, a mobile phone) may simultaneously have hardware modules of a plurality of wireless communication protocols capable of operating simultaneously, and these hardware modules of the wireless communication protocols can operate simultaneously. The wireless communication protocols are, for example, 2^{nd}-generation (2G), 3^{rd}-generation (3G), fourth-generation (4G), long term evolution (LTE), wireless fidelity (Wi-Fi), blue-tooth, global positioning system (GPS), international GNSS service (IGS) communication protocols, etc.

In order to increase a data transmission rate of the electronic equipment, the electronic equipment can simultaneously adopt a plurality of wireless communication protocols to transmit data in an integrated manner Each of the wireless communication protocols has different transmitting (Tx) and receiving (Rx) frequency bands. When the electronic equipment transmits data simultaneously through a plurality of wireless communication protocols, the transmitting signals may have a spike noise on the receiving frequency band of the operated communication protocol due to an inter-modulation effect, and the electronic equipment probably receives the spike noise through an antenna, which may influence signal receiving sensitivity. For example, when the hardware modules of the Wi-Fi and LTE communication protocols in the electronic equipment simultaneously transmit data, transmitting (Tx) signals of the Wi-Fi and LTE communication protocols probably produce the spike noise on the receiving (Rx) frequency band of the LTE communication protocol of Band 7 due to the inter-modulation effect.

In order to resolve the above problem, besides that the electronic equipment can avoid transmitting data simultaneously through a plurality of the communication protocols, manufacturers also consider to avoid a receiving terminal of the electronic equipment from receiving the noise generated by the signals sent by the antennas of the electronic equipment itself due to the inter-modulation effect.

### SUMMARY

The disclosure is directed to a wireless communication device, in which a signal filter is configured at a receiving terminal of a wireless communication protocol transceiver, so as to avoid a situation that the wireless communication device receives signals sent by the wireless communication device itself through a plurality of wireless communication protocols. In this way, the signals sent through the wireless communication signals do not produce noises due to an inter-modulation effect, and the wireless communication device is avoided to receive the noises, so as to improve sensitivity of the wireless communication device for receiving data.

The disclosure provides a wireless communication device including a first wireless communication protocol transceiver, a second wireless communication protocol transceiver, a signal frequency splitter and a signal filter. The first wireless communication protocol transceiver transmits data through a first wireless communication protocol. The second wireless communication protocol transceiver has a receiving terminal. The signal frequency splitter splits a receiving signal received by a second antenna and a transmitting signal transmitted by the second antenna according to a receiving frequency band and a transmitting frequency band of a second wireless communication protocol. The signal filter is coupled to the signal frequency splitter and the receiving terminal of the second wireless communication protocol transceiver. The signal filter filters a signal in a receiving frequency band of the first wireless communication protocol and the receiving frequency band of the second wireless communication protocol.

In an embodiment of the disclosure, the second wireless communication protocol transceiver further includes a transmitting terminal. The wireless communication device further includes a surface acoustic wave filter and a signal amplifier. The surface acoustic wave filter is coupled to the transmitting terminal of the second wireless communication protocol transceiver, and is configured to filter the transmitting signal sent by the transmitting terminal. The signal amplifier is coupled to the surface acoustic wave filter and a signal receiving terminal of the signal frequency splitter. The signal amplifier is configured to receive and amplify the filtered transmitting signal.

In an embodiment of the disclosure, the first wireless communication protocol is a wireless fidelity (Wi-Fi) communication protocol, and the second wireless communication protocol is a long term evolution (LTE) communication protocol on band 7.

In an embodiment of the disclosure, the signal frequency splitter is a duplexer.

In an embodiment of the disclosure, the signal filter is a high pass filter or a band pass filter.

According to the above descriptions, the signal filter is configured at the receiving terminal of the second wireless communication protocol transceiver, and the signal filter is used for filtering the signal in the receiving frequency band of the first wireless communication protocol (the Wi-Fi communication protocol) and in the receiving frequency band of the second wireless communication protocol (the LTE communication protocol of band 7). In this way, when the wireless communication device simultaneously uses the above two wireless communication protocols to perform data transmission, the noise produced by the transmitting signals of the two wireless communication protocols due to the inter-modulation effect is avoided. In this way, the noise is not received by the second wireless communication protocol (the LTE communication protocol of band 7) transceiver. Therefore, data receiving sensitivity of the wireless communication device on the second wireless communication protocol (the LTE communication protocol of band 7) is improved.

In order to make the aforementioned and other features and advantages of the disclosure comprehensible, several exemplary embodiments accompanied with figures are described in detail below.

### BRIEF DESCRIPTION OF THE DRAWINGS

The accompanying drawings are included to provide a further understanding of the disclosure, and are incorporated in and constitute a part of this specification. The drawings illustrate embodiments of the disclosure and, together with the description, serve to explain the principles of the disclosure.

FIG. 1 is a schematic diagram of a wireless communication device.

FIG. 2 is a frequency spectrum diagram of transmitting signals and noise of Wi-Fi and LTE of band 7.

FIG. 3 is a block diagram of a wireless communication device according to an embodiment of the disclosure.

FIG. 4 is a circuit diagram of a signal filter according to an embodiment of the disclosure.

FIG. 5 is a block diagram of a wireless communication device according to another embodiment of the disclosure.

### DETAILED DESCRIPTION OF DISCLOSED EMBODIMENTS

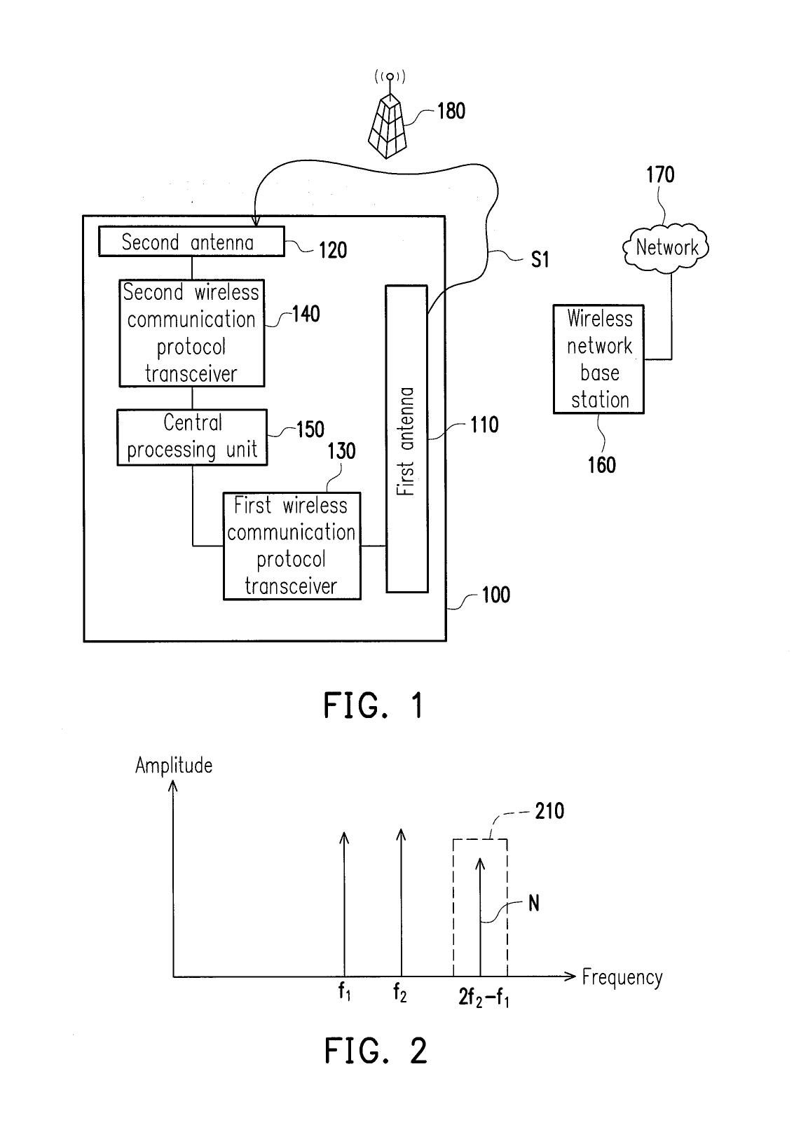

FIG. 1 is a schematic diagram of a wireless communication device 100. Referring to FIG. 1, the wireless communication device 100 includes a first antenna 110, a second antenna 120, a first wireless communication protocol transceiver 130, a second wireless communication protocol transceiver 140 and a central processing unit 150. A first wireless communication protocol of the present embodiment can be a wireless fidelity (Wi-Fi) communication protocol, and a second wireless communication protocol can be a long term evolution (LTE) communication protocol of band 7. The first antenna 110 can be complied with a transmitting frequency band of the Wi-Fi communication protocol. The second antenna 120 can be complied with a transmitting frequency band of a 2^{nd}-generation (2G)/3^{rd}-generation (3G)/fourth-generation (4G)/LTE communication protocol. The central processing unit 150 is connected to and controls the first wireless communication protocol transceiver 130 and the second wireless communication protocol transceiver 140, so as to simultaneously use the first and the second wireless communication protocols to transmit data. Those skilled in the art can arbitrarily adjust the types of the first and the second wireless communication protocols according to an actual requirement, which are not limited as that described above.

The encountered problem of the disclosure is described below. FIG. 2 is a frequency spectrum diagram of transmitting signals and noise of Wi-Fi and LTE of the band 7. Referring to FIG. 1 and FIG. 2, a transmitting (Tx) frequency band of Wi-Fi is 2412 MHz, i.e. 2412 MHz is taken as a frequency f1 of the transmitting signal of Wi-Fi. A transmitting (Tx) frequency band of LTE of the band 7 is about between 2520 MHz and 2540 MHz, i.e. 2540 MHz is taken as a frequency f2 of the transmitting signal of LTE of the band 7. A receiving (Rx) frequency band of LTE of the band 7 is about between 2625 MHz and 2685 MHz, which is indicated by a dot line frame 210 in FIG. 2. When the first wireless communication protocol transceiver 130 in the wireless communication device 100 transmits a transmitting signal of the transmission frequency f1 to a wireless network base station 160 and a network 170 through the first antenna 110, meanwhile, the second wireless communication protocol transceiver 140 transmits a transmitting signal of the transmission frequency f2 to a base station 180, a part of signal S1 generated by the first antenna 110 is probably received by the second antenna 120, or since the first wireless communication protocol transceiver 130 and the second wireless communication protocol transceiver 140 are disposed on a same circuit board, the transmitting signal of the transmission frequency f1 of the first wireless transmission protocol (Wi-Fi) and the transmitting signal of the transmission frequency f2 of the second wireless transmission protocol (LTE, band 7) produce a noise N with a frequency of 2f2-f1at a receiving terminal of the second wireless transmission protocol transceiver 140 due to an inter-modulation effect. Since a value of 2f2-f1 is about 2668 MHz, which is within the receiving (Rx) frequency band of LTE of the band 7 (2625 MHz-2685 MHz), the noise N with the frequency of 2668 MHz may influence data receiving sensitivity of the second wireless communication protocol transceiver 140.

Therefore, in the embodiment of the disclosure, a signal filter is configured to the receiving terminal of the second wireless communication protocol transceiver, and the signal filter is used for filtering a signal in a receiving frequency band of the first wireless communication protocol (Wi-Fi) and a receiving frequency band of the second wireless communication protocol (LTE, band 7). In this way, when the wireless communication device simultaneously uses the aforementioned two wireless communication protocols to transmit data, it is avoided that the noise generated by the transmitting signals of the two wireless communication protocols due to the inter-modulation effect is received by the second wireless communication protocol (LTE, band 7) transceiver.

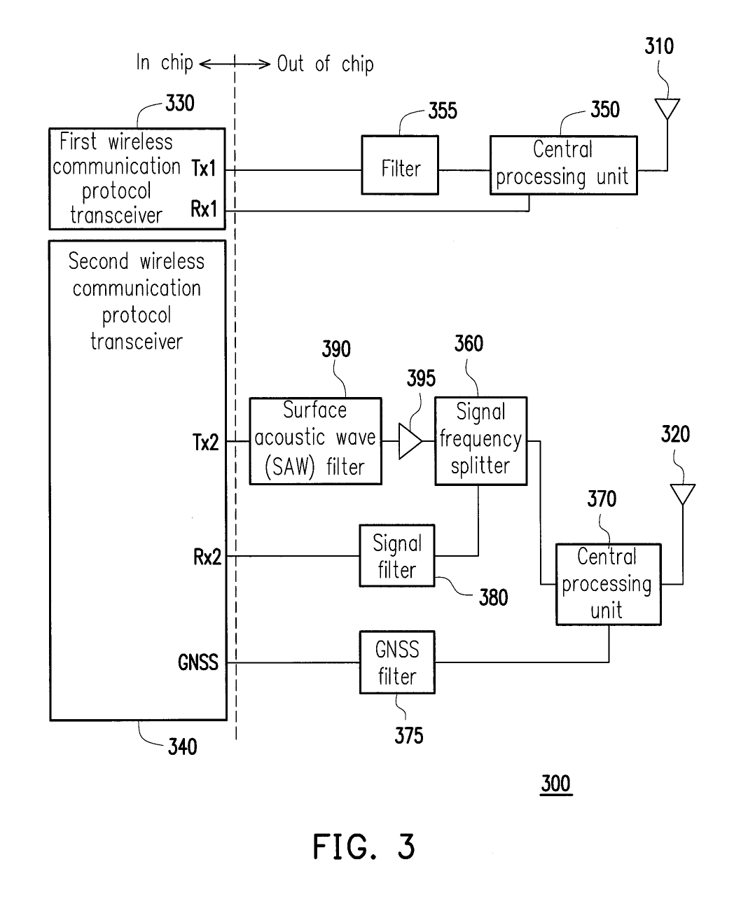

FIG. 3 is a block diagram of a wireless communication device 300 according to an embodiment of the disclosure. The wireless communication device 300 can be a smart phone, a notebook computer, a tablet personal computer (PC), or an electronic equipment simultaneously using two wireless communication protocols to perform data transmission. The wireless communication device 300 mainly includes a first antenna 310, a second antenna 320, a first wireless communication protocol transceiver 330, a second wireless communication protocol transceiver 340, a signal frequency splitter 360 and a signal filter 380. In the present embodiment, the first wireless communication protocol can be the Wi-Fi communication protocol, and the second wireless communication protocol can be the LTE communication protocol of band 7. Therefore, the first antenna 310 can be complied with a transmitting frequency band of the Wi-Fi communication protocol. The second antenna 120 can be complied with a transmitting frequency band of a 2G/3G/4G/LTE communication protocol. Moreover, the first wireless communication protocol transceiver 330 and the second wireless communication protocol transceiver 340 are respectively located on different chips.

The wireless communication device 300 further includes a duplexer 350 used by the first wireless communication protocol (Wi-Fi), a duplexer 370 used by the second wireless communication protocol (LTE), a filter 355 located at a transmitting terminal Tx1 of the Wi-Fi transceiver, a surface acoustic wave (SAW) filter 390 and a signal amplifier 395 located at a transmitting terminal Tx2 of the LTE of band 7 transceiver. In the present embodiment, the first wireless communication protocol transceiver 330 is the Wi-Fi transceiver, and a chip model number thereof can be WCN3660. The first wireless communication protocol transceiver 330 has the transmitting terminal Tx1 and a receiving terminal Rx1. The duplexer 350 used by the Wi-Fi communication protocol classifies the receiving/transmitting signal, so as to respectively provide the received receiving signal to the receiving terminal Rx1 of the first wireless communication protocol transceiver 330 and transmit the transmitting signal generated at the transmitting terminal Tx1 of the first wireless communication protocol transceiver 330 and processed by the filter 355 to the first antenna 310.

On the other hand, the second wireless communication protocol transceiver 340 is the LTE of band 7 transceiver, and a chip model number thereof can be WTR1605L. The second wireless communication protocol transceiver 340 has a transmitting terminal Tx2 and a receiving terminal Rx2. The duplexer 370 used by the LTE communication protocol can classify the signals according to the respective receiving/transmitting frequency band of the 2G/3G/4G/LTE communication protocol for transmitting to different wireless communication protocol receiver. The signal frequency splitter 360 used by the LTE of band 7 is a duplexer, and a chip model number thereof is ACMD-6207, which is used for receiving/transmitting signals complied with the LTE receiving/transmitting frequency band.

It should be noticed that in the present embodiment of the disclosure, the signal filter 380 is configured between the receiving terminal Rx2 of the second wireless communication protocol transceiver 340 and the signal frequency splitter 360. The signal filter 380 is used for filtering a signal in the receiving frequency band of the Wi-Fi communication protocol and in the receiving frequency band of the LTE communication protocol of band 7. In other words, referring to FIG. 2, since the receiving (Rx) frequency band of the LTE communication protocol of band 7 is about between 2625 MHz and 2685 MHz (which is indicated by the dot line frame 210), in order to avoid a situation that the second wireless communication protocol transceiver 340 of FIG. 3 receives the noise generated by the transmitting signals of the frequency f1 and the frequency f2 due to the inter-modulation effect, in the present embodiment of the disclosure, the signal filter 380 capable of filtering the transmitting signals of the frequency f1 and the frequency f2 is configured in front of the receiving terminal Rx2 of the second wireless communication protocol transceiver 340. In this way, when the wireless communication device 300 of FIG. 3 simultaneously uses the Wi-Fi communication protocol and the LTE communication protocol of band 7 to perform data transmission, the signal filter 380 can filter the signals of the frequency f1 and the frequency f2 that are transmitted by antennas or transmitted through the circuit board, so as to avoid generating the noise N of FIG. 2. Since the noise N is not generated, data transmitting sensitivity of the second wireless communication protocol transceiver 340 is improved.

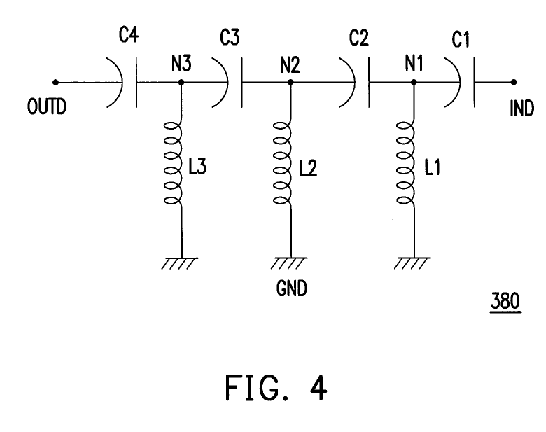

In the present embodiment, the signal filter 380 can be a high pass filter or a band pass filter, for example, the signal filter 380 is a high pass filter of FIG. 4. Those skilled in the art can replace the signal filter 380 by other types of the high pass filter or the band pass filter, so as to filter the signal in the receiving frequency band of the first wireless communication protocol (Wi-Fi) and in the receiving frequency band of the second wireless communication protocol (LTE of band 7). FIG. 4 is a circuit diagram of the signal filter 380 according to an embodiment of the disclosure. The signal filter 380 includes a plurality of capacitors C1-C4 and a plurality of inductors L1-L3. The capacitors C1-C4 are connected in series. A first terminal of each of the inductors L1-L3 is respectively connected to one of a plurality of nodes N1-N3 between the capacitors C1-C4 connected in series to each other. A second terminal of each of the inductors L1-L3 is coupled to a ground voltage GND. For example, the first terminal of the inductor L1 is connected to the node N1 between the capacitors C1 and C2 connected in series to each other, the first terminal of the inductor L2 is connected to the node N2 between the capacitors C2 and C3 connected in series to each other, and the first terminal of the inductor L3 is connected to the node N3 between the capacitors C3 and C4 connected in series to each other. An input terminal IND of the signal filter 380 is coupled to the signal frequency splitter 360 of FIG. 3, and an output terminal OUTD of the signal filter 380 is coupled to the receiving terminal Rx2 of the second wireless communication protocol transceiver 340. In the present embodiment, the signal filter 380 formed by the capacitors C1-C4 and the inductors L1-L3 can filter signals with a frequency lower than 2540 MHz, so as to filter the transmitting signals with the frequency f1 and the frequency f2 shown in FIG. 2.

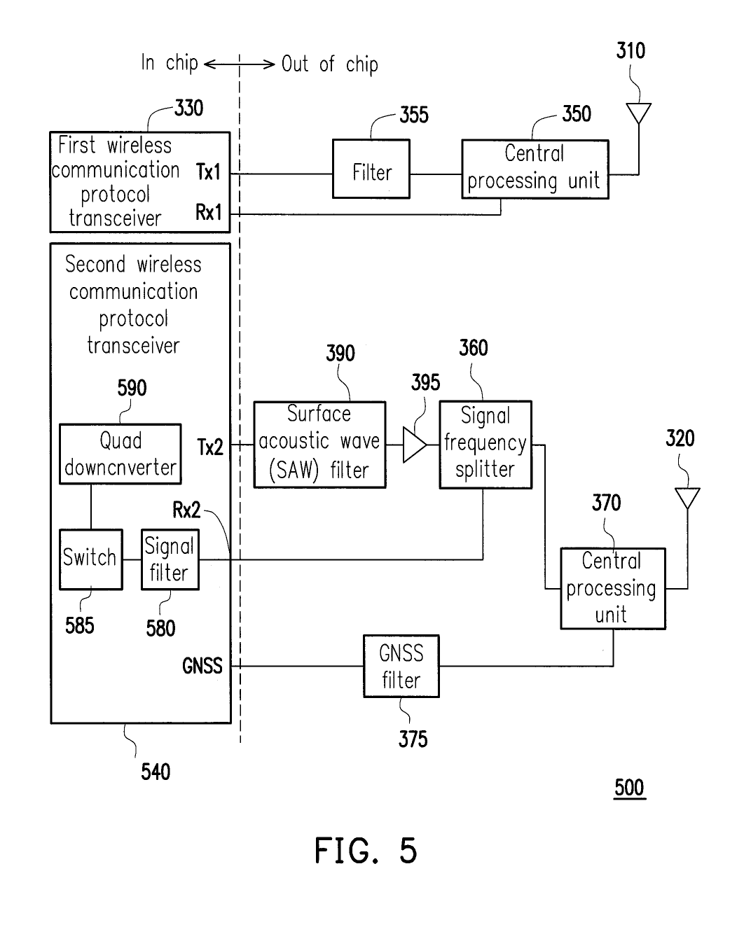

In the present embodiment, the signal filter 380 of FIG. 3 can be configured on a circuit board, and is not configured in the chip of the second wireless communication protocol transceiver 340. In another embodiment of the disclosure, the signal filter can also be configured in the chip of the second wireless communication protocol transceiver. FIG. 5 is a block diagram of a wireless communication device 500 according to another embodiment of the disclosure. A difference between FIG. 3 and FIG. 5 is that a signal filter 580 of FIG. 5 is disposed in the chip of a second wireless communication protocol transceiver 540. The receiving signal received by the receiving terminal Rx2 of the second wireless communication protocol transceiver 540 first passes through the signal filter 580 to filter the signal with the transmission frequency of the first wireless communication protocol (Wi-Fi) and the transmission frequency of the second wireless communication protocol (LTE, band 7), and the filtered receiving signal is further processed by a switch 585 and a quad downconverter 590.

Referring back to FIG. 3, in order to ensure a better quality of the transmitting signal generated at the transmitting terminal Tx2 of the second wireless communication protocol transceiver 340, in the wireless communication device 300 of the present embodiment, a signal processing circuit is configured between the signal frequency splitter 360 and the transmitting terminal Tx2. The signal processing circuit may include the SAW filter 390 and the signal amplifier 395. The SAW filter 390 is coupled to the transmitting terminal Tx2 of the second wireless communication protocol transceiver 340, which is used for filtering the transmitting signal sent from the transmitting terminal Tx2. The signal amplifier 395 is coupled to the SAW filter 390 and a signal receiving terminal of the signal frequency splitter 360. The signal amplifier 395 is used for receiving and amplifying the filtered transmitting signal.

In the present embodiment, since the second wireless communication protocol transceiver 340 with the chip model number of ACMD-6207 further has a signal processing function of an international GNSS service (IGS), the duplexer 370 and a GNSS filter 375 can be used to transmit GNSS information received through the second antenna 320 to a terminal GNSS of the second wireless communication protocol transceiver 340, such that the wireless communication device 300 can obtain the GNSS information.

In summary, in the disclosure, the signal filter is configured at the receiving terminal of the second wireless communication protocol transceiver, and the signal filter is used for filtering the signal in the receiving frequency band of the first wireless communication protocol (the Wi-Fi communication protocol) and in the receiving frequency band of the second wireless communication protocol (the LTE communication protocol of band 7). In this way, when the wireless communication device simultaneously uses the above two wireless communication protocols to perform data transmission, the noise produced by the transmitting signals of the two wireless communication protocols due to the inter-modulation effect is avoided. In this way, the noise is not received by the second wireless communication protocol (the LTE communication protocol of band 7) transceiver. Therefore, data receiving sensitivity of the wireless communication device on the second wireless communication protocol (the LTE communication protocol of band 7) is improved.

It will be apparent to those skilled in the art that various modifications and variations can be made to the structure of the disclosure without departing from the scope or spirit of the disclosure. In view of the foregoing, it is intended that the disclosure cover modifications and variations of this disclosure provided they fall within the scope of the following claims and their equivalents.

What is claimed is:

1. A wireless communication device, comprising:
a first wireless communication protocol transceiver, transmitting data through a first wireless communication protocol;
a second wireless communication protocol transceiver, having a receiving terminal;
a signal frequency splitter, splitting a receiving signal received by a second antenna and a transmitting signal transmitted by the second antenna according to a receiving frequency band and a transmitting frequency band of a second wireless communication protocol; and
a signal filter, coupled to the signal frequency splitter and the receiving terminal of the second wireless communication protocol transceiver, and filtering a signal in a receiving frequency band of the first wireless communication protocol and the receiving frequency band of the second wireless communication protocol.

2. The wireless communication device as claimed in claim 1, wherein the second wireless communication protocol transceiver further comprises a transmitting terminal, and the wireless communication device further comprises:
a surface acoustic wave filter, coupled to the transmitting terminal of the second wireless communication protocol transceiver, and configured to filter the transmitting signal sent by the transmitting terminal; and
a signal amplifier, coupled to the surface acoustic wave filter and a signal receiving terminal of the signal frequency splitter, and configured to receive and amplify the filtered transmitting signal.

3. The wireless communication device as claimed in claim 2, wherein the first wireless communication protocol is a wireless fidelity (Wi-Fi) communication protocol, and the second wireless communication protocol is a long term evolution (LTE) communication protocol on band 7.

4. The wireless communication device as claimed in claim 3, wherein the signal frequency splitter is a duplexer.

5. The wireless communication device as claimed in claim 4, wherein the signal filter is a high pass filter or a band pass filter.

6. The wireless communication device as claimed in claim 5, wherein the signal filter comprises:
a plurality of capacitors, connected to each other in series; and
a plurality of inductors, wherein a first terminal of each of the inductors is coupled to one of a plurality of nodes between the capacitors connected in series to each other, and a second terminal of each of the inductors is coupled to a ground voltage.

7. The wireless communication device as claimed in claim 5, wherein the signal filter is configured in the second wireless communication protocol transceiver, and is coupled to the receiving terminal of the second wireless communication protocol transceiver.

8. The wireless communication device as claimed in claim 5, further comprising:
a first antenna, coupled to the first wireless communication protocol transceiver, wherein the first wireless communication protocol transceiver transmits data through the first antenna by using the first wireless communication protocol.

9. The wireless communication device as claimed in claim 5, further comprising:
a central processing unit, coupled to and controlling the first wireless communication protocol transceiver and the second wireless communication protocol transceiver.

10. The wireless communication device as claimed in claim 5, wherein a chip model number of the first wireless communication protocol transceiver is WCN3660, a chip model number of the second wireless communication protocol transceiver is WTR1605L, and a chip model number of the signal frequency splitter is ACMD6207.

11. The wireless communication device as claimed in claim 1, wherein the first wireless communication protocol is a wireless fidelity (Wi-Fi) communication protocol, and the second wireless communication protocol is a long term evolution (LTE) communication protocol on band 7.

12. The wireless communication device as claimed in claim 1, wherein the signal frequency splitter is a duplexer.

13. The wireless communication device as claimed in claim 1, wherein the signal filter is a high pass filter or a band pass filter.

14. The wireless communication device as claimed in claim 1, wherein the signal filter comprises:
a plurality of capacitors, connected to each other in series; and
a plurality of inductors, wherein a first terminal of each of the inductors is coupled to one of a plurality of nodes between the capacitors connected in series to each other, and a second terminal of each of the inductors is coupled to a ground voltage.

15. The wireless communication device as claimed in claim 1, wherein the signal filter is configured in the second wireless communication protocol transceiver, and is coupled to the receiving terminal of the second wireless communication protocol transceiver.

16. The wireless communication device as claimed in claim 15, wherein the signal filter is a high pass filter or a band pass filter.

17. The wireless communication device as claimed in claim 15, wherein the signal filter comprises:
a plurality of capacitors, connected to each other in series; and
a plurality of inductors, wherein a first terminal of each of the inductors is coupled to one of a plurality of nodes between the capacitors connected in series to each other, and a second terminal of each of the inductors is coupled to a ground voltage.

18. The wireless communication device as claimed in claim 1, further comprising:
a first antenna, coupled to the first wireless communication protocol transceiver, wherein the first wireless communication protocol transceiver transmits data through the first antenna by using the first wireless communication protocol.

19. The wireless communication device as claimed in claim 1, further comprising:
a central processing unit, coupled to and controlling the first wireless communication protocol transceiver and the second wireless communication protocol transceiver.

20. The wireless communication device as claimed in claim 1, wherein a chip model number of the first wireless communication protocol transceiver is WCN3660, a chip model number of the second wireless communication protocol transceiver is WTR1605L, and a chip model number of the signal frequency splitter is ACMD6207.
